(19) United States
(12) Patent Application Publication
(10) Pub. No.: US 2026/0160568 A1
(43) Pub. Date: Jun. 11, 2026

(54) Timeline Tasks for Embodied Agent Planning and Reasoning

(71) Applicant: Google LLC, Mountain View, CA (US)

(72) Inventors: Victor Carbune, Zurich (CH); Kevin Allekotte, Zurich (CH)

(21) Appl. No.: 18/972,138

(22) Filed: Dec. 6, 2024

(51) Int. Cl. G01C 21/34

(52) U.S. Cl. CPC G01C 21/3484

(57) ABSTRACT

A computing device obtains routing information for a route traveled by a user. The routing information includes traveled route information that is descriptive of a first route from a first location to a second location that is provided to a user. The routing information further includes trip metadata obtained from application(s) (e.g., mapping application) executed by the computing device during the user's traversal of the route. The computing device stores a first timeline entry that is based on the routing information in an indexing structure, which includes a plurality of timeline entries. Responsive to a routing query from the user, the computing device retrieves the first timeline entry based on a degree of similarity between the first timeline entry and the routing query. The computing device generates second routing information that is descriptive of a second route to a third location, which is based on the first timeline entry.

### FIELD

The present disclosure relates generally to providing personalized routing decisions for a user based on personal timeline data associated with the user. More particularly, the present disclosure relates to generating routing decisions for a user in a privacy-preserving manner by processing timeline data using a machine-learned model that is trained using personal timeline data associated with the user.

### BACKGROUND

Cloud computing generally refers to large, distributed networks of computing resources (e.g., Central Processing Units (CPUs), memory, storage, etc.) used to deliver computing services (e.g., servers, storage, databases, networking, software, etc.) over the internet. Cloud computing systems enable users to access resources and applications from anywhere with an internet connection, without the need for physical infrastructure or on-premises hardware. Cloud computing systems are conventionally implemented in partnership with cloud computing platforms. Generally, a cloud computing platform will own a distributed network of computing resources that can be leveraged by users to implement cloud systems that the user develops. In addition, many cloud computing systems leverage virtualization technology, such as containers or virtual machines, to more efficiently allocate computing resources to users. For example, rather than assigning a CPU core exclusively to a user, a cloud platform may instantiate multiple virtual machines to implement cloud computing systems for multiple users, and the virtual machine can utilize the CPU core on an as-needed basis.

Cloud computing resources may be used to facilitate and/or implement a variety of services, such as application-based services. An application-based service generally provides a service to a user via an application executed by the user's device. Examples of such services include mapping services, aggregation services (e.g., for user reviews, etc.), visual search services, etc. Conventional navigation services provided by mapping applications typically include routing features to route a user from a starting location to a particular desired destination. In some instances, navigation services will also offer supplemental features to aid users in discovering nearby locations, planning trip itineraries, determining routes, and/or the like.

### SUMMARY

Aspects and advantages of embodiments of the present disclosure will be set forth in part in the following description, or can be learned from the description, or can be learned through practice of the embodiments.

One example aspect of the present disclosure is directed to a method. The method includes obtaining, by a computing device comprising one or more processor devices, routing information for a route traveled by a user. The routing information includes traveled route information descriptive of a first route from a first location to a second location provided to a user and trip metadata obtained from one or more applications executed by the computing device during traversal of the route taken by the user. The one or more applications include a mapping application. The method further includes storing, by the computing device, a first timeline entry in an indexing structure comprising a plurality of timeline entries, the first timeline entry being based on the routing information. The method further includes, responsive to a routing query from the user, retrieving, by the computing device, the first timeline entry based on a degree of similarity between the first timeline entry and the routing query. The method further includes generating, by the computing device, second routing information descriptive of a second route to a third location, the third location being based on the first timeline entry.

Another example aspect of the present disclosure is directed to a computing device. The computing device includes one or more processor devices. The computing device further includes one or more non-transitory computer-readable media that collectively store instructions that, when executed by the one or more processors, cause the computing device to perform operations. The operations include obtaining routing information for a route traveled by a user. The routing information includes traveled route information descriptive of a first route from a first location to a second location provided to a user and trip metadata obtained from one or more applications executed by the computing device during traversal of the route taken by the user. The one or more applications include a mapping application. The operations further include storing a first timeline entry in an indexing structure comprising a plurality of timeline entries, the first timeline entry being based on the routing information. The operations further include, responsive to a routing query from the user, retrieving the first timeline entry based on a degree of similarity between the first timeline entry and the routing query. The operations further include generating second routing information descriptive of a second route to a third location, the third location being based on the first timeline entry.

Another example aspect of the present disclosure is directed to a non-transitory computer readable medium comprising instructions that, when executed by one or more processors of a computing device, cause the one or more processors to perform operations. The operations include obtaining routing information for a route traveled by a user. The routing information includes traveled route information descriptive of a first route from a first location to a second location provided to a user and trip metadata obtained from one or more applications executed by the computing device during traversal of the route taken by the user. The one or more applications include a mapping application. The operations further include storing a first timeline entry in an indexing structure comprising a plurality of timeline entries, the first timeline entry being based on the routing information. The operations further include, responsive to a routing query from the user, retrieving the first timeline entry based on a degree of similarity between the first timeline entry and the routing query. The operations further include generating second routing information descriptive of a second route to a third location, the third location being based on the first timeline entry.

Other aspects of the present disclosure are directed to various systems, apparatuses, non-transitory computer-readable media, user interfaces, and electronic devices.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system that performs operations according to example embodiments of the present disclosure;

FIG. 2 depicts an illustrative visualization of an example mapping interface according to example embodiments of the present disclosure;

FIG. 3A depicts an illustrative visualization of the example mapping interface of FIG. 2 given a routing query specifying an accessible destination according to example embodiments of the present disclosure;

FIG. 3B depicts an illustrative visualization of the example mapping interface of FIG. 2 given a routing query specifying an inaccessible destination according to example embodiments of the present disclosure;

FIG. 4 depicts a flowchart diagram of an example method according to example embodiments of the present disclosure; and

FIGS. 5A-5C depict block diagrams of example computing systems that perform operations according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Generally, example aspects of the present disclosure are directed to providing personalized routing decisions based on a user's personal timeline data. More particularly, example aspects of the present disclosure are directed to generating routing decisions in a privacy-preserving manner by processing timeline data stored locally on a user's device using a machine-learned model that has been trained using the user's personal timeline data. For instance, in some examples, a computing device (e.g., a user device, etc.) may obtain routing information for a route traveled by a user. The routing information may include traveled route information descriptive of a first route from a first location to a second location provided to a user (e.g., a route from a home location to a work location, etc.). The routing information may also include trip metadata obtained from one or more applications executed by the computing device during traversal of the route previously taken by the user. For instance, in some examples, if the user is traveling to work, the trip metadata may include information obtained from a mapping application while the user traverses the route. The trip metadata may also include information obtained from other applications accessed by the user during traversal of the route, such as messaging applications, calendar applications, and/or the like. The computing device may store a first timeline entry in an indexing structure that includes a plurality of timeline entries. The first timeline entry may be based on the routing information, and prior timeline entries may be based on prior routing information associated with prior routes traveled by the user.

Responsive to a routing query from the user, the computing device may retrieve the first timeline entry based on a degree of similarity between the first timeline entry and the routing query. The computing device may generate second routing information descriptive of a second route to a third location. The third location may be based at least in part on the first timeline entry. For instance, in some examples, assume that the first timeline entry is based on a route from a home location to a location for a certain type of recreational activity, and the routing query from the user is a request for a route from the home location to a location for a similar type of recreational activity. The computing device may retrieve the first timeline entry based on a degree of similarity between the first timeline entry and the routing query, and may generate the second routing information based on the first timeline entry. In this manner, the computing device may provide personalized routing suggestions based on the user's personal timeline data.

Aspects of the present disclosure provide a number of technical effects and benefits. As one example, aspects of the present disclosure provide a technical improvement to the functioning of the computer. More specifically, some devices, such as user devices (e.g., smartphones, tablets, etc.) may lack the computing resources necessary to utilize machine-learned models for inference. In such instances, a user device may offload the processing of the machine-learned model to a remote computing device that possesses the computing resources necessary to process the machine-learned model. However, offloading sensitive user information (e.g., personal timeline data) to a remote computing device may expose such information to malicious actors. As such, conventional approaches may either expose sensitive user information to malicious actors, or may produce sub-optimal results by utilizing the model locally without the necessary computing resources. Accordingly, implementations described herein may provide optimal results while retaining user privacy by processing sensitive user information using a machine-learned model executed in a personalized computing enclave that is isolated from other computing environments and is configured to execute machine-learned models in a secure and privacy-preserving manner.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” do not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures. Furthermore, unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

In the drawings and specification, there have been disclosed typical embodiments and, although specific terms are employed, they are used in a generic and descriptive sense only and not for purposes of limitation of the scope set forth in the following claims. Furthermore, like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

With reference now to the Figures, example embodiments of the present disclosure will be discussed in further detail.

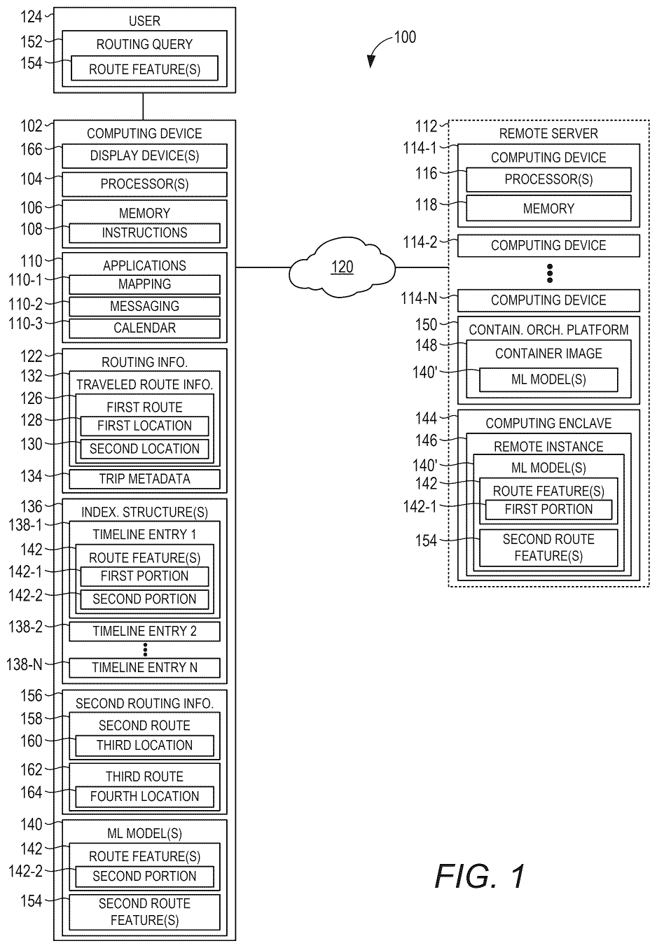

FIG. 1 depicts an example computing system 100 according to example embodiments of the present disclosure. The computing system 100 may be suitable, for instance, for implementing the examples methods and/or processes described herein. In some examples, the computing system 100 may include and/or may otherwise be implemented by one or more computing devices. In instances in which the computing system 100 includes plural server computing devices, such server computing devices may operate according to sequential computing architectures, parallel computing architectures, and/or some combination thereof.

As shown, the computing system 100 may include a computing device 102, such as a user computing device (e.g., smartphone, tablet, laptop, etc.). The computing device 102 may include one or more processor devices 104 and a memory 106. The one or more processor devices 104 may be any suitable processing device (e.g., a processor core, a microprocessor, an ASIC, an FPGA, a controller, a microcontroller, etc.) and may be one processor or a plurality of processors that are operatively connected. The memory 106 may include one or more non-transitory computer-readable storage medium(s), such as RAM, ROM, EEPROM, EPROM, flash memory devices, magnetic disks, etc., and combinations thereof. The one or more non-transitory computer-readable media (e.g., memory 106) may collectively store data, such as instructions 108 that, when executed by the processor device(s) 104, cause the computing device 102 to perform operations, such as any of the operations described herein.

In some examples, the computing device 102 may further include, and be operable to execute, one or more applications 110, such as, by way of non-limiting example, a mapping application 110-1, a messaging application 110-2, a calendar application 110-3, and/or the like.

The computing system 100 may further include one or more remote servers 112. The remote server 112 may include one or more remote computing devices 114. Each remote computing device 114 may include one or more processor devices 116 and a memory 118.

The one or more processor devices 116 may be any suitable processing device (e.g., a processor core, a microprocessor, an ASIC, an FPGA, a controller, a microcontroller, etc.) and may be one processor or a plurality of processors that are operatively connected. The memory 118 may include one or more non-transitory computer-readable storage medium(s), such as RAM, ROM, EEPROM, EPROM, flash memory devices, magnetic disks, etc., and combinations thereof. The one or more non-transitory computer-readable media (e.g., memory 118) may collectively store data, such as instructions (not shown) that, when executed by the processor device(s) 116, cause the computing device 114 and/or the remote server 112 to perform operations, such as any of the operations described herein.

The computing device 102 may be communicatively coupled to the remote server 112 over a network 120. As discussed in greater detail below, the computing device 102 may, in some examples, communicate data to the remote server 112 over the network 120. The network 120 may be any suitable type of communications network, such as a local area network (e.g., intranet), wide area network (e.g., Internet), and/or some combination thereof and may include any number of wired or wireless links. In general, communication over the network 120 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The computing device 102 may be configured to obtain routing information 122 for a user 124 of the computing device 102. As described in greater detail below, the routing information 122 may be for a route traveled by the user 124, such as a first route 126 from a first location 128 to a second location 130. More particularly, in some examples, the route traveled by the user may be a route 126 previously provided to the user 124 (e.g., a route from a home location to a work location, etc.). Additionally and/or alternatively, in some examples, the route traveled by the user may be a route 126 that the user 124 is currently traversing. In some examples, the routing information 122 may indicate a sequence of transportation network segments (e.g., roads, streets, highways, bridges, tunnels, etc.) and/or transportation network nodes (e.g., intersections, etc.) that are traversed by the user 124 during traversal of the route 126.

In some examples, the routing information 122 may include traveled route information 132. The traveled route information 132 may be descriptive of the route 126 traveled by the user 124. For instance, in some examples, the traveled route information 132 may include the sequence of transportation network segments and/or transportation network nodes that are traversed by the user during traversal of the route 126. As another non-limiting example, the traveled route information 132 may include a temporal information indicative of a time at which each transportation network segment and/or transportation network node is traversed by the user 124 during traversal of the route 126. Additionally and/or alternatively, in some examples, the traveled route information 132 may indicate intermediary locations that are traversed by the user 124 during traversal of the route 126 (e.g., stops made by the user 124 during traversal of the route 126 taken by the user 124, etc.).

In some examples, the routing information 122 may include trip metadata 134. The trip metadata 134 may be obtained from the one or more applications 110 (e.g., mapping application 110-1, messaging application 110-2, calendar application 110-3, etc.) executed by the computing device 102 while the user 124 traversed the route 126. For instance, in some examples, the trip metadata 134 may include information obtained from the mapping application 110-1 that displays the route 126 to the user 124 while the user 124 traverses the route 126. As another non-limiting example, the trip metadata 134 may include information obtained from the messaging application 110-2 that is used by the user 124 while the user 124 traverses the route 126. As another non-limiting example, the trip metadata 134 may include information obtained from the calendar application 110-3 that is used by the user 124 while the user 124 traverses the route 126 (e.g., a meeting, an appointment, an event, etc.). As another non-limiting example, the trip metadata 134 may include information obtained from another application 110, such as a weather application, a social media application, and/or the like.

Additionally and/or alternatively, in some examples, the trip metadata 134 may be obtained from data sources other than applications (e.g., applications 110) executed by the computing device 102, such as a third-party data source (e.g., a weather service, a new service, etc.). For instance, in some examples, the trip metadata 134 may include information obtained from a weather service that provides weather information associated with the route 126 traversed by the user 124. As another non-limiting example, the trip metadata 134 may include information obtained from a news service that provides news information associated with the route 126 traversed by the user 124.

The computing device 102 may further include an indexing structure 136. As shown, the indexing structure 136 may include a plurality of timeline entries 138 (e.g., first timeline entry 138-1, second timeline entry 138-2, . . . nth timeline entry 138-N). More particularly, the computing device 102 may be configured to store a first timeline entry 138-1 in the indexing structure 136. The first timeline entry 138-1 may be based on the routing information 122. In some examples, the first timeline entry 138-1 may include, and/or may otherwise be based on, the traveled route information 132 included in the routing information 122. In some examples, the first timeline entry 138-1 may include, and/or may otherwise be based on, the trip metadata 134 included in the routing information 122.

The indexing structure 136 that stores the timeline entries 138 may be any suitable data structure that enables the computing device 102 to store and retrieve the timeline entries 138. In some examples, the timeline entries 138—with the exception of the first timeline entry 138-1—stored by the indexing structure 136 may be based on prior routing information (e.g., similar to the routing information 122) associated with prior routes traveled by the user 124.

As one non-limiting illustrative example, assume that the user 124 previously traveled from his/her home to a business that serves ice cream. The computing device 102 may store a timeline entry 138 in the indexing structure 136 that is based on the routing information 122 associated with the route (e.g., first route 126) traveled from the user's home (e.g., first location 128) to the business that serves ice cream (e.g., second location 130). The traveled route information 132 of the corresponding timeline entry 138 may include the sequence of transportation network segments and/or transportation network nodes that are traversed by the user 124 during traversal of the route (e.g., first route 126) from the user's home (e.g., first location 128) to the business that serves ice cream (e.g., second location 130). The traveled route information 132 of the corresponding timeline entry 138 may further include and/or otherwise indicate any other intermediary locations that are traversed by the user 124. The trip metadata 134 of the corresponding timeline entry 138 may include information obtained from the applications 110 accessed by the user 124 during traversal of the route (e.g., first route 126) from the user's home (e.g., first location 128) to the business (e.g., second location 130), such as, by way of non-limiting example, a photo that depicts ice cream from that location captured using a camera application, textual content exchanged with another use via a messaging application, weather information obtained at a time at which the user 124 traveled to the business, and/or the like.

The computing device 102 may further include one or more machine-learned models 140. In some examples, prior to storing the first timeline entry 138-1 in the indexing structure 136, the computing device 102 may process the routing information 122 with the (e.g., local) machine-learned model 140 executed on the computing device 102 to identify a plurality of route features 142. In some examples, the plurality of route features 142 may be included in the first timeline entry 138-1 that is ultimately stored in the indexing structure 136. In some examples, the machine-learned model 140 may be trained with data that is specific to the user 124, such as the timeline entries 138. In this manner, the computing device 102 may process (e.g., locally) the routing information 122 in a personalized fashion (e.g., relative to the user 124) without exposing any information specific to the user 124.

Additionally and/or alternatively, in some examples, the computing device 102 may provide the routing information 122 to an isolated computing enclave 144. The isolated computing enclave 144 may be personalized for the user 124. It should be understood that the terms “isolated computing enclave” and “personalized computing enclave” are used interchangeably herein. The isolated computing enclave 144 may be isolated from other computing environments and may, as discussed in greater detail below, be configured to execute machine-learned models in a secure and privacy-preserving manner. For instance, in some examples, the isolated computing enclave 144 may preserve user privacy by enforcing data retention policies that prevent the retention of user information (e.g., by deleting any personal data associated with the user 124 immediately after use, by anonymizing data associated with the user 124 prior to processing the data with a machine-learned model, etc.). In this manner, the isolated computing enclave 144 may ensure privacy by isolating user-specific data and securely processing the same.

The isolated computing enclave 144 may be dynamically instantiated as part of a load-balancing process. When a user device (e.g., computing device 102) requests processing of timeline data (e.g., routing information 122, timeline entries 138, etc.), the computing system 100 may determine the optimal location for processing the data. For instance, if the computing device 102 requests processing of timeline data (e.g., routing information 122, timeline entries 138, etc.), the processing may be performed locally (e.g., on the computing device 102) if the computing device 102 has sufficient computing resources available.

Alternatively, if the computing device 102 lacks sufficient computing resources, the computing system 100 may dynamically instantiate the isolated computing enclave 144 on the remote server 112. The isolated computing enclave 144 may be provisioned based on factors such as, by way of non-limiting example, resource availability, network latency, security considerations, and/or the like. The computing system 100 may use a load balancer (not shown) to distribute requests across available enclaves, thereby ensuring efficient utilization of resources while minimizing latency. By dynamically instantiating enclaves as needed, the computing system 100 may provide a scalable and secure solution for processing sensitive user data while, simultaneously, maintaining privacy and minimizing performance impacts on user devices.

More particularly, the isolated computing enclave 144 may include a personalized instance 146 of one or more machine-learned models, such as the machine-learned models 140. The machine-learned models executed by the isolated computing enclave 144 are hereinafter referred to as “machine-learned model(s) 140′.” The machine-learned model 140′may be saved to a container image 148, which may be deployed to a container orchestration platform 150, thereby allowing for the dynamic instantiation of personalized computing enclaves (e.g., isolated computing enclave 144) as needed. Storing the machine-learned model 140′ (e.g., user-personalized machine-learned model) to the container image 148 may provide user privacy by ensuring that the machine-learned model 140′is only accessible to the computing device 102 and/or the isolated computing enclave 144. This approach prevents unauthorized access to the machine-learned model 140′and the sensitive user data (e.g., timeline entries 138, routing information 122) the machine-learned model 140′was trained on. By deploying the container image 148 to a container orchestration platform 150, the computing system 100 may dynamically instantiate personalized computing enclaves (e.g., isolated computing enclave 144) as needed, which further enhances user privacy by isolating data associated with the user 124 and processing such data securely.

As noted above, in some examples, the computing device 102 may provide the routing information 122 (e.g., at least the trip metadata 134) to the personalized computing enclave 144. For instance, in some examples, the computing device 102 may establish a network connection (e.g., via network 120) to the remote server 112. The network connection may be an encrypted communication link between the computing device 102 and the remote server 112. The network connection may be encrypted using any suitable secure protocol, such as Transport Layer Security (TLS) and/or the like, to protect the data transmitted therebetween from unauthorized access. The computing device 102 may also use a secure authentication mechanism to verify the identity of the isolated computing enclave 144 prior to transmitting the data. That is, the computing device 102 may use any suitable secure authentication mechanism to determine that the isolated computing enclave 144 is specific to the user 124 before providing the routing information 122 to the isolated computing enclave 144 for processing.

The personalized computing enclave 144 may process the routing information 122 (e.g., at least the trip metadata 134) via the machine-learned model 140′to identify and/or generate the plurality of route features 142. Responsive to generating the plurality of route features 142, the personalized computing enclave 144 may provide the plurality of route features 142 to the computing device 102. Responsive to receiving the plurality of route features 142 from the personalized computing enclave 144, the computing device 102 may store the first timeline entry 138-1, which may include the plurality of route features 142, in the indexing structure 136.

In some examples, a portion of the plurality of route features 142 may be generated and/or identified by both the machine-learned model 140 (e.g., local to the computing device 102) and the machine-learned model 140′ (e.g., remote instance executed by the personalized computing enclave 144). More particularly, in some examples, the computing device 102 may provide the routing information 122 (e.g., at least the trip metadata 134) to the personalized computing enclave 144. The personalized computing enclave 144 may process the routing information 122 (e.g., at least the trip metadata 134) and may generate and/or identify a first portion 142-1 of the plurality of route features 142. The computing device 102 may also process the routing information 122 (e.g., at least the traveled route information 132) with the machine-learned model 140 (e.g., executed on the computing device 102) to identify a second portion 142-2 of the plurality of route features 142. The computing device 102 may receive the first portion 142-1 of the plurality of route features 142 from the personalized computing enclave 144 and may store the first timeline entry 138-1—which includes the first portion 142-1 of the plurality of route features 142 (e.g., generated and/or identified by the personalized computing enclave 144) and the second portion 142-2 of the plurality of route features 142 (e.g., generated and/or identified by the computing device 102)—in the indexing structure 136.

In some examples, the user 124 may provide a routing query 152 to the computing device 102. In such examples, responsive to the routing query 152, the computing device 102 may retrieve the first timeline entry 138-1 from the indexing structure 136 based on a degree of similarity between the first timeline entry 138-1 and the routing query 152. As described herein, a “similarity” between the first timeline entry 138-1 and the routing query 152 may refer to a degree of similarity between features identified from the timeline entry and/or features identified or extracted from the routing query 152. Examples of extracted features may include, as non-limiting examples, route segments that are traversed by the user 124 during traversal of the route 126, intermediary locations that are traversed by the user 124 during traversal of the route 126, temporal information indicative of a time at which each transportation network segment and/or transportation network node is traversed by the user 124 during traversal of the route 126, intermediary locations that are traversed by the user 124 during traversal of the route 126 (e.g., intermediate stops made by the user 124 during traversal of the route 126 taken by the user, etc.), textual content exchanged with another user via a messaging application 110-2, and/or the like.

Additionally and/or alternatively, in some examples, the extracted features may include higher-level information derived from more basic features extracted from the routing query 152. As one non-limiting example, assume that the routing query 152 includes an image of a desired destination. The routing query 152 may be processed with an encoder model to generate an intermediate representation of the image of the desired destination. The intermediate representation may then be processed with a machine-learned model, such as a language model and/or the like, to generate a semantic textual description of the desired destination depicted by the image included in the routing query 152. In this way, features extracted from content included in the routing query 152 (and/or the routing query 152 itself) may be refined to further extract additional features from the routing query 152.

In some examples, the routing query 152 may be processed to obtain additional features, and a “similarity” evaluation may then be performed using the obtained additional features. As one non-limiting example, assume that the routing query 152 specifies multiple routes (e.g., “should I take the backroads or the highway?”). Based on the routing query 152, two (or more) of the plurality of timeline entries 138 corresponding to the candidate routes specified in the routing query 152 (e.g., backroads, highways, etc.) may be identified and compared based on the features of each corresponding timeline entry 138. That is, a timeline entry 138 corresponding to a prior route to a specified destination that primarily uses the highway may be compared to a different timeline entry 138 corresponding to a prior route to the specified destination that primarily uses non-highway roads (e.g., local roads, unmarked roads, rural roads, minor arterial roads, state roads, etc.).

In some examples, the machine-learned model(s) 140 (and/or machine-learned model(s) 140′) may be leveraged to process the routing query 152 to provide additional information to the user 124. As one non-limiting example, a pre-generated prompt may be provided to the machine-learned model(s) 140 and/or machine-learned model(s) 140′that instructs the machine-learned model(s) 140 (and/or machine-learned model(s) 140′) to summarize, identify, etc. the high-level objectives of the route specified by the routing query 152. Alternatively, the pre-generated prompt may instead instruct the machine-learned model(s) 140 (and/or machine-learned model(s) 140′) to perform a similar analysis of the route feature(s) 142, the timeline entries 138, and/or the like. Information resulting from such analyses may be utilized as a contextual input to the machine-learned model(s) 140 (and/or machine-learned model(s) 140′) and/or may be presented to the user 124 (e.g., via display device(s) 166).

In some examples, the computing device 102 may retrieve a timeline entry 138 from the indexing structure 136 based on a degree of similarity between a portion of the corresponding timeline entry 138 and the routing query 152. For instance, the first timeline entry 138-1 may include a first portion of features (not shown) and a second portion of features (not shown). In some examples, the first portion of features identified in the first timeline entry 138-1 may be similar to the routing query 152, but the second portion of features identified in the first timeline entry 138-1 may be dissimilar, unrelated, etc. to the routing query 152. In such examples, responsive to the routing query 152, the computing device 102 may retrieve the first timeline entry 138-1 from the indexing structure 136 based on the degree of similarity between the first portion of the first timeline entry 138-1 and the routing query 152.

In some examples, responsive to the routing query 152 from the user 124, the computing device 102 may determine that at least one of the plurality of route features 142 matches at least one corresponding second route feature of a plurality of second route features 154. More particularly, the plurality of second route features 154 may be associated with and/or otherwise based on the routing query 152. In some examples, the computing device 102 may process the routing query 152 with the machine-learned model 140 (e.g., executed on the computing device 102) to obtain an output descriptive of the plurality of second route features 154.

Additionally and/or alternatively, in some examples, the computing device 102 may provide the routing query 152 to the personalized computing enclave 144 specific to the user 124. The personalized computing enclave 144, which executes the machine-learned model 140′ (e.g., remote instance 146 of the machine-learned model 140), may process the routing query 152 to generate and/or identify the plurality of second route features 154.

In some examples, the routing query 152 received from the user 124 may specify a particular destination (e.g., a particular grocery store, a particular ice cream shop, etc.). If the particular destination is inaccessible (e.g., the ice cream shop is closed, etc.), the computing device 102 may search the indexing structure 136 to determine whether any of the timeline entries 138 are associated with a destination that is similar to the particular destination. For instance, in some examples, the computing device 102 may determine that one of the timeline entries 138 is associated with the same type of destination, a similar type of destination, etc. to the particular destination. The computing device 102 may retrieve the identified timeline entry 138 that includes a route to the destination that is similar to the particular destination requested by the user 124 (e.g., a different grocery store, a different ice cream shop, etc.). In some examples, the degree of similarity between the first timeline entry 138-1 and the routing query 152 may be based on a distance between the requested destination and the destination selected by the computing device 102.

Additionally and/or alternatively, in some examples, the routing query 152 received from the user 124 may specify a particular type of destination (e.g., a business, a restaurant, a coffee shop, a grocery store, etc.). The computing device 102 may perform a search for an entry associated with the particular type of destination in the indexing structure 136. For instance, in some examples, the computing device 102 may search the indexing structure 136 for a timeline entry 138 that includes a route to a destination that is associated with the particular type of destination (e.g., a different business, a different restaurant, a different coffee shop, a different grocery store, etc.).

The term “route” as described throughout the subject specification may also refer to a particular destination, location, sequence of locations, or a combination of these. For instance, a “route” may represent a specific point of interest (POI) like a restaurant, a sequence of locations visited during a trip, or even a general area of interest.

Additionally and/or alternatively, in some examples, the routing query 152 received from the user 124 may specify a particular type of route (e.g., a fast route, a scenic route, a route that includes access to electric vehicle chargers, etc.). The computing device 102 may perform a search for an entry (e.g., timeline entry 138) associated with the particular type of route in the indexing structure 136. For instance, in some examples, assume that the user 124 commonly selects scenic routes that are less efficient than other routes. Further assume that the user 124 requests a scenic route to a particular destination. The computing device 102 may search the indexing structure 136 for a timeline entry 138 that includes a route previously selected by the user 124 for that particular destination. If the user 124 has previously selected a scenic route to the particular destination, the computing device 102 may retrieve the timeline entry 138.

Alternatively, if the user 124 has not previously selected a scenic route to the particular destination, the computing device 102 may search the indexing structure 136 for a timeline entry 138 that includes a scenic route traveled by some other user that is similar to the user 124 in a privacy-preserving manner. For instance, in some examples, the trip metadata 134 may include anonymized features that indicate a preference of the user 124 for scenic routes. The timeline entry 138 selected by the computing device 102 may include similar anonymized features from the other user. Based on a similarity between the features, the computing device 102 may determine the timeline entry 138 to likely include a scenic route as requested by the user 124.

The computing device 102 may generate and/or retrieve second routing information 156. In some examples, the second routing information 156 may include a second route 158 to a third location 160. In some examples, the second routing information 156 may further include a third route 162 to a fourth location 164. Hence, in some examples, the second routing information 156 may serve as an itinerary for a trip described by the user 124 via the routing query 152.

More particularly, in some examples, the computing device 102 may be configured to select routes from the indexing structure 136 to form an itinerary for a trip, route, destination, etc. requested by the user 124 that match the routing query 152, such as the desired location, time of year, type of activities, and/or the like. For instance, in some examples, the routing query 152 may indicate a location, a duration of stay (e.g., a day, a week, a month, etc.), a purpose for a trip (e.g., a vacation, visiting relatives, exploring a new city, etc.), and/or the like.

As one illustrative example, the routing query 152 received from the user 124 may describe a trip to a particular geographic area (e.g., city, country, geographic region, town, etc.). The computing device 102 may retrieve a plurality of timeline entries 138 based on the routing query 152. In some examples, the retrieved timeline entries 138 may include a route, and/or a destination, previously taken by the user 124 while visiting that particular geographic area (e.g., identified in the routing query 152). Additionally and/or alternatively, in some examples, the retrieved timeline entries 138 may include a route, and/or a destination, previously taken by other users similar to the user 124 while visiting that particular geographic area (e.g., identified in the routing query 152). In this manner, the computing device 102 may provide personalized routing suggestions (e.g., second routing information 154) based on the personal timeline data (e.g., timeline entries 138, routing information 122, etc.) of the user 124.

In some examples, the computing device 102 may then use the trip metadata 134 associated with the timeline entries 138 to create the personalized itinerary for the user 124. For instance, in some examples, if the user 124 requests a vacation to a beach destination during the summer, the computing device 102 may identify timeline entries 138 that include trips to beach destinations during the summer. The computing device 102 may then use the trip metadata 134 associated with the timeline entries 138, such as the locations of restaurants, attractions, activities, and/or the like, to create a personalized itinerary for the user 124. The computing device 102 may also use the trip metadata 134 to identify potential transportation options for the user 124, such as flights, rental cars, public transportation, and/or the like.

Additionally and/or alternatively, the user 124 may use the computing device 102 (e.g., mapping application 110-1) to explore a first destination and identify potential things to do at the first destination. In examples where the user 124 has never visited the first destination (e.g., no timeline entries 138 are associated with the first destination), the computing device 102 may identify timeline entries 138 that are associated with a second destination that is similar to—but not the same as—the first destination. In such examples, the computing device 102 may then use the trip metadata 134 associated with the corresponding timeline entry 138 (e.g., that corresponds to the second destination) to generate a personalized itinerary for the user 124 if and/or when the user 124 visits the first destination. Hence, the computing device 102 may provide personalized recommendations, itineraries, and/or the like for destinations and/or locations never visited by the user 124 by identifying timeline entries 138 associated with similar destinations and/or locations visited by the user 124.

In some examples, responsive to generating the second routing information 156, the computing device 102 may provide the second routing information 156 to the user 124. For instance, in some examples, the computing device 102 may display the second routing information 156 to the user 124 via a user interface, such as a display device 166, of the computing device 102. Additionally and/or alternatively, in some examples, the computing device 102 may provide the second routing information 156 to a remote display device (not shown) via the network 120. In this manner, the computing device 102 may provide personalized routing suggestions (e.g., second routing information 156) to the user 124 based on the user's personal timeline data (e.g., timeline entries 138, routing information 122).

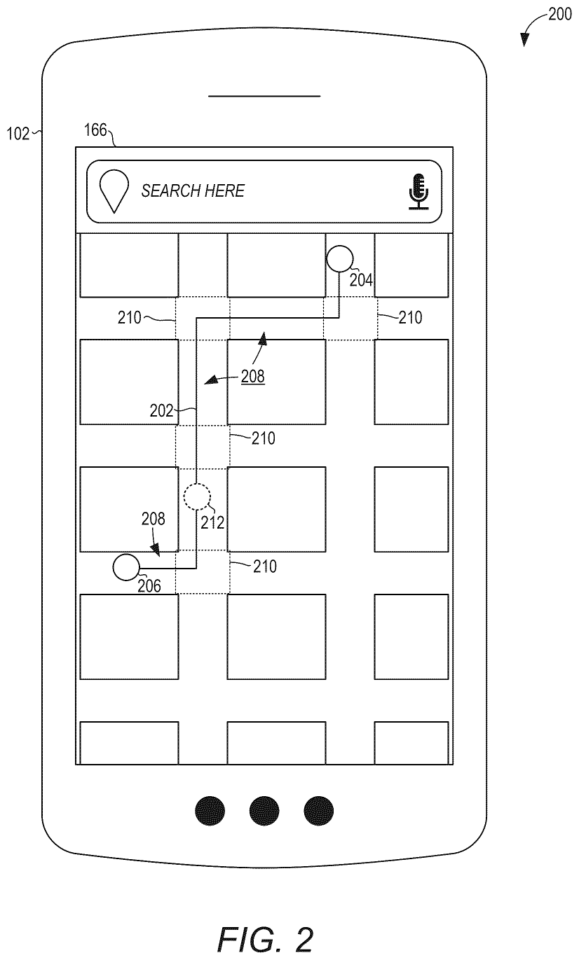

FIG. 2 depicts an illustrative visualization of an example mapping interface 200 according to example embodiments of the present disclosure. FIG. 2 is discussed below in conjunction with FIG. 1. It should be understood that, although depicted in FIG. 2 as a mobile smartphone device, the computing device 102 may be any suitable computing device operable to perform the operations described herein without deviating from the scope of the present disclosure.

As shown, the user 124 may be provided with a route 202 from a first location 204 to a second location 206. In some examples, the route 202 may be provided to the user 124 via the display device 166 of the computing device 102. For instance, in the example depicted in FIG. 2, a mapping application 110-1 of the computing device 102 may display the route 202 to the user 124 (e.g., via display device 166).

The computing device 102 may be configured to obtain routing information 122 for a route traveled by the user 124, such as the route 202. As described above, the routing information 122 may include traveled route information 132 and trip metadata 134. For instance, in the example depicted in FIG. 2, the routing information 122 may include traveled route information 132 that is descriptive of the route 202 from the first location 204 to the second location 206. By way of non-limiting example, the traveled route information 132 may include the sequence of transportation network segments 208 traversed by the user 124 during traversal of the route 202. As shown, the transportation network segments 208 may correspond to roads, streets, highways, bridges, tunnels, and/or the like, along the route 202. By way of another non-limiting examples, the traveled route information 132 may include the sequence of transportation network nodes 210 traversed by the user 124 during traversal of the route 202. As shown, the transport network nodes 210 may correspond to intersections along the route 202. By way of another non-limiting example, the traveled route information 132 may include temporal information indicative of a time at which each transportation network segment 208 and/or transportation network node 210 is traversed by the user 124 during traversal of the route 202. By way of another non-limiting example, the traveled route information 132 may also indicate intermediary locations 212 that are traversed by the user 124 during traversal of the route 202 (e.g., stops made by the user 124 during traversal of the route 202 taken by the user 124).

Likewise, in the example depicted in FIG. 2, the routing information 122 may include trip metadata 134 obtained from the one or more applications 110 executed by the computing device 102 during traversal of the route 202 taken by the user. For instance, as described above, the user 124 may use the one or more applications 110 during traversal of the route 202, such as the mapping application 110-1, the messaging application 110-2, the calendar application 110-3, and/or the like. The trip metadata 134 may also be obtained from data sources other than the applications 110 executed on the computing device 102, such as a third-party data source (e.g., a weather service, a new service, etc.).

The computing device 102 may store a first timeline entry 138-1, which may be based on the routing information 122 (e.g., traveled route information 132, trip metadata 134, etc.), in an indexing structure 136 of the computing device 102. The first timeline entry 138-1 may include a plurality of route features 142 associated with and/or corresponding to the route 202 traversed by the user 124.

More particularly, in some examples, the computing device 102 may process the routing information 122 (e.g., at least the trip metadata 134) with a local machine-learned model executed on the computing device, such as the machine-learned model 140, to identify a plurality of route features 142. Additionally and/or alternatively, in some examples, the computing device 102 may provide the routing information 122 (e.g., at least the trip metadata 134) to a personalized computing enclave, such as the computing enclave 144, which is specific to the user 124 and is configured to execute a remote instance 146 of the machine-learned model 140 (e.g., machine-learned model 140′). Responsive to providing the routing information 122 (e.g., at least the trip metadata 134) to the computing enclave 144, the computing device 102 may receive the plurality of route features 142 from the computing enclave 144. In this manner, the plurality of route features 142 may be based at least in part on the routing information 122 associated with the route 202 traversed by the user 124.

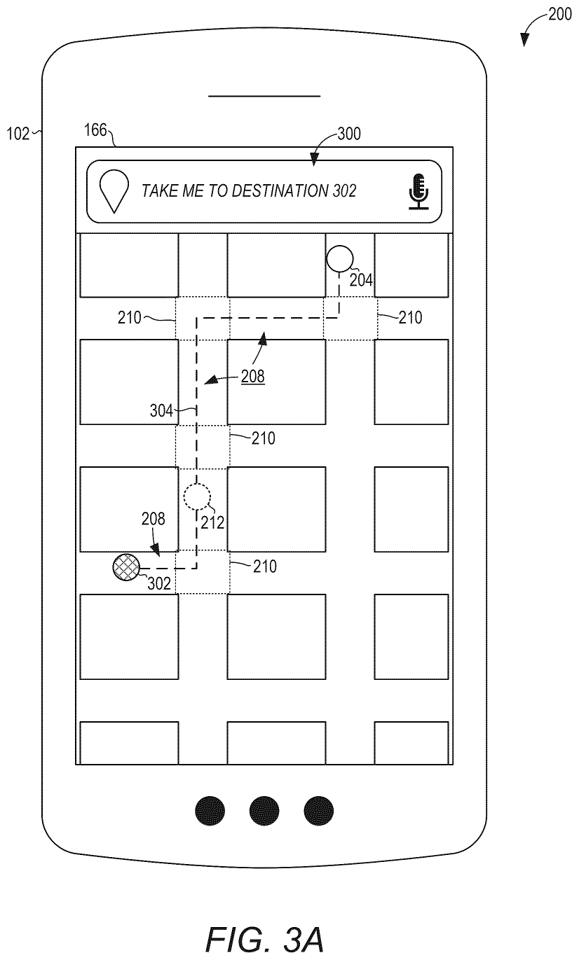

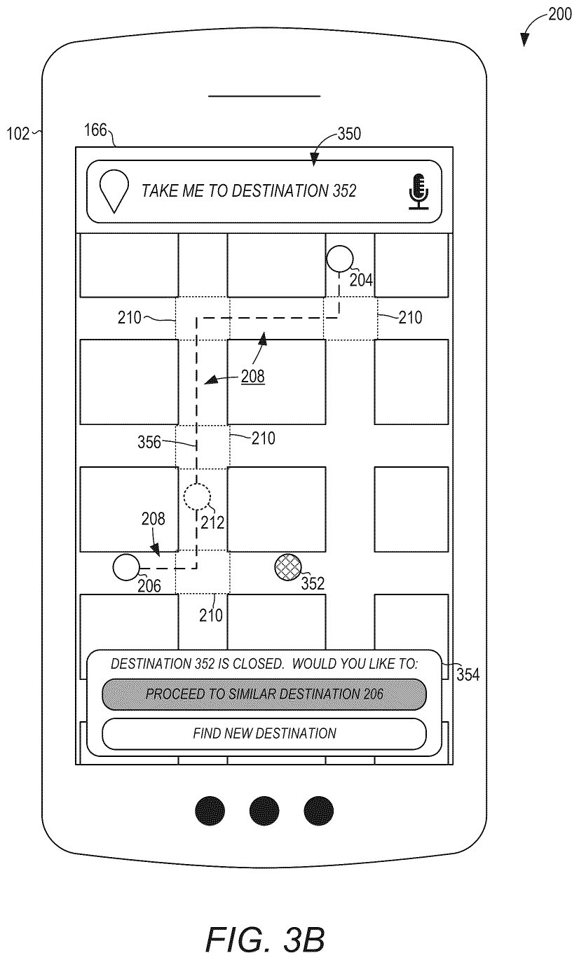

FIGS. 3A-3B depict illustrative visualizations of the example mapping interface 200 described above with reference to FIG. 2 according to example embodiments of the present disclosure. More particularly, FIG. 3A depicts the mapping interface 200 when given a routing query (e.g., routing query 300) that specifies an accessible destination (e.g., particular destination 302), and FIG. 3B depicts the mapping interface 200 when given a routing query (e.g., routing query 350) that specifies an inaccessible destination (e.g., particular destination 352). FIGS. 3A-3B are discussed below in conjunction with FIGS. 1-2. It should be understood that, although depicted in FIGS. 3A-3B as a mobile smartphone device, the computing device 102 may be any suitable computing device operable to perform the operations described herein without deviating from the scope of the present disclosure.

Referring now to FIG. 3A, the user 124 may provide a routing query 300. In some examples, the routing query 300 received from the user 124 may specify a particular destination 302. Responsive to the routing query 300, the computing device 102 may retrieve one or more of the plurality of timeline entries 138 stored in the indexing structure 136 based on a degree of similarity between the timeline entries 138 and the routing query 300.

More particularly, in the example depicted in FIG. 3A, the computing device 102 may determine that at least one of the plurality route features 142 associated with and/or corresponding to the route 202 matches at least one corresponding second route feature of a plurality of second route features 154. As described above, the plurality of second route features 154 may be based on the routing query 300.

More particularly, in some examples, the computing device 102 may process the routing query 300 with the local machine-learned model 140 executed on the computing device 102 to obtain an output descriptive of the plurality of second route features 154. Additionally and/or alternatively, in some examples, the computing device 102 may provide the routing query 300 to the personalized computing enclave 144, which is configured to execute the remote instance 146 of the machine-learned model 140 (e.g., machine-learned model 140′). In such examples, responsive to providing the routing query 300 to the personalized computing enclave 144, the computing device 102 may receive the plurality of second route features 154 from the personalized computing enclave 144.

In the illustrative example depicted in FIG. 3A, the routing query 300 received from the user 124 may specify the second location 206 as the particular destination 302. As such, the computing device 102 may determine that the route features 142 associated with the route 202 match the second route features 154 associated with the routing query 300. In response, the computing device 102 may retrieve the first timeline entry 138-1 from the indexing structure 136 and may generate second routing information 156 that is descriptive of a second route 304. Given the degree of similarity between the routing query 300 and the first timeline entry 138-1, the second route 304 may be similar to the route 202. That is, as shown, the second route 304 may be from the first location 204 to a third location, which corresponds to the particular destination 302 specified by the routing query 300. Responsive to generating the second routing information 156, the computing device 102 may provide the second routing information 156 to the user 124 via the display device 166.

Referring now to FIG. 3B, the user 124 may provide a routing query 350. In some examples, the routing query 350 received from the user 124 may specify a particular destination 352. Responsive to the routing query 350, the computing device 102 may retrieve one or more of the plurality of timeline entries 138 stored in the indexing structure 136 based on a degree of similarity between the timeline entries 138 and the routing query 350.

In the illustrative example depicted in FIG. 3B, the routing query 350 received from the user 124 may specify a particular destination 352. However, in contrast to the example described above with reference to FIG. 3A, the computing device 102 may determine that the particular destination 352 specified by the routing query 350 is inaccessible. For instance, as one non-limiting example, the particular destination 352 may correspond to a business that is closed at the time the routing query 350 is received from the user 124. However, in such examples, the computing device 102 may search the indexing structure 136 to determine whether any of the timeline entries 138 are associated with a destination that is similar to the particular destination 352 specified by the routing query 350.

In the example depicted in FIG. 3B, the computing device 102 may determine (e.g., based on the second route features 154 associated with routing query 350) that the particular destination 352 specified by the routing query 350 is similar to the second location 206 associated with the route 202. Given the degree of similarity between the routing query 350 and the first timeline entry 138-1 (e.g., second location 206), the computing device 102 may provide a prompt 354 to the user 124 (e.g., via the display device 166), which allows the user 124 to either proceed to the second location 206 or instruct the computing device 102 to search (e.g., the indexing structure 136) for a different alternative destination.

In the example depicted in FIG. 3B, the user 124 may choose to proceed to the second location 206 instead of the particular destination 352 specified by the routing query 350. In response, the computing device 102 may retrieve the first timeline entry 138-1 from the indexing structure 136 and may generate second routing information 156 that is descriptive of a second route 356. Given the degree of similarity between the particular destination 352 specified by the routing query 350 and the second location 206 of the first timeline entry 138-1, the second route 356 may be similar to the route 202. That is, as shown, the second route 356 may be from the first location 204 to a third location, which corresponds to the second location 206. Responsive to generating the second routing information 156, the computing device 102 may provide the second routing information 156 to the user 124 via the display device 166.

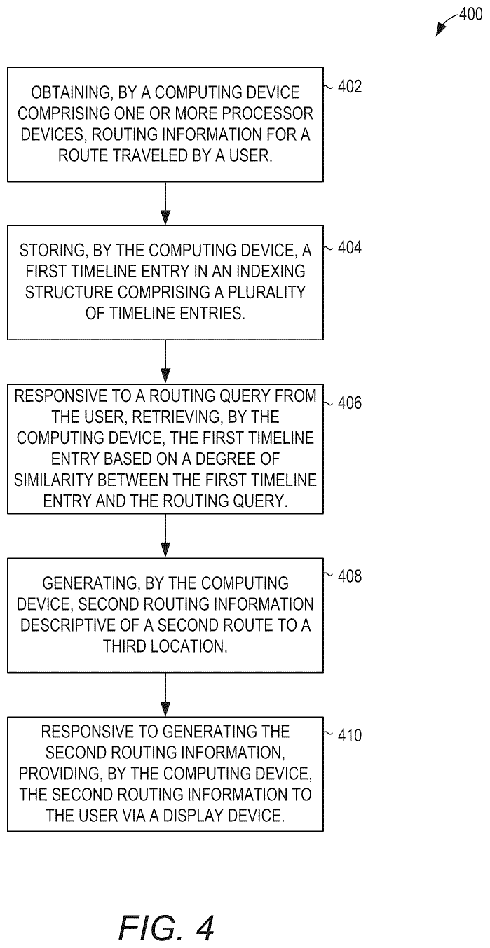

FIG. 4 depicts a flow diagram of an example computer-implemented method 400 to perform according to example embodiments of the present disclosure. One or more portion(s) of the method may be implemented by one or more computing devices such as, for example, the computing devices described herein. Moreover, one or more portion(s) of the method may be implemented as an algorithm on the hardware components of the device(s) described herein. Although FIG. 4 depicts steps performed in a particular order for purposes of illustration and discussion, the methods of the present disclosure are not limited to the particularly illustrated order or arrangement. The various steps for the method 400 may be omitted, rearranged, combined, and/or adapted in various ways without deviating from the scope of the present disclosure.

At (402), a computing device, which includes one or more processor devices, may obtain routing information for a route traveled by a user. In some examples, the routing information may include traveled route information descriptive of a first route from a first location to a second location provided to a user. Additionally, in some examples, the routing information may include trip metadata obtained from one or more applications executed by the computing device during traversal of the route taken by the user. By way of non-limiting example, the one or more applications may include mapping application(s), messaging application(s), calendar application(s), and/or the like.

At (404), the computing device may store a first timeline entry in an indexing structure. The indexing structure may include a plurality of timeline entries. The first timeline entry (e.g., stored at (404)) may be based on the routing information (e.g., obtained at (402)).

In some examples, the computing device may provide at least the trip metadata to a personalized computing enclave specific to the user. The personalized computing enclave may be configured to execute a remote instance of a machine-learned model that is personalized for the user. More particularly, the computing device may establish a network connection (e.g., encrypted communication link) to a remote server, which is configured to instantiate the personalized computing enclave. Responsive to determining that the personalized computing enclave is specific to the user, the computing device may transmit at least the trip metadata to the personalized computing enclave via the network connection.

In some examples, responsive to providing the at least the metadata to the personalized computing enclave, the computing device may receive a plurality of route features from the personalized computing enclave. The computing device may store the first timeline entry, which may include the plurality of route features, in the indexing structure.

In some examples, responsive to providing the at least the metadata to the personalized computing enclave, the computing device may receive a first portion of the plurality of route features from the personalized computing enclave. In such examples, the computing device may process the traveled route information with a local machine-learned model executed on the computing device to identify a second portion of the plurality of route features. The computing device may store the first timeline entry, which may include the first portion of the plurality of route features and the second portion of the plurality of route features, in the indexing structure.

Additionally and/or alternatively, in some examples, the computing device may process at least the trip metadata with a local machine-learned model executed on the computing device to identify a plurality of route features. The computing device may store the first timeline entry, which may include the plurality of route features, in the indexing structure.

At (406), responsive to a routing query from the user, the computing device may retrieve the first timeline entry based on a degree of similarity between the first timeline entry and the routing query. In some examples, the computing device may determine that at least one of the plurality of route features matches at least one corresponding second route feature of a plurality of second route features. The plurality of second route features may be based on the routing query.

More particularly, in some examples, the computing device may process the routing query with the local machine-learned model executed on the computing device to obtain an output descriptive of the plurality of second route features.

Additionally and/or alternatively, in some examples, the computing device may provide the routing query to the personalized computing enclave (e.g., executing a remote instance of the local machine-learned model). In such examples, responsive to providing the at least the trip metadata to the personalized computing enclave, the computing device may receive the plurality of second route features from the personalized computing enclave.

At (408), the computing device may generate second routing information, which may be descriptive of a second route to a third location. The third location may be based at least in part on the first timeline entry. In some examples, the computing device may generate second routing information that is further descriptive of a third route to a fourth location, which may be based at least in part on the first timeline entry.

At (410), responsive to generating the second routing information, the computing device may provide the second routing information to the user. By way of non-limiting example, the computing device may provide the second routing information to the user via a display device, such as a display device of the computing device, a remote display device, and/or the like.

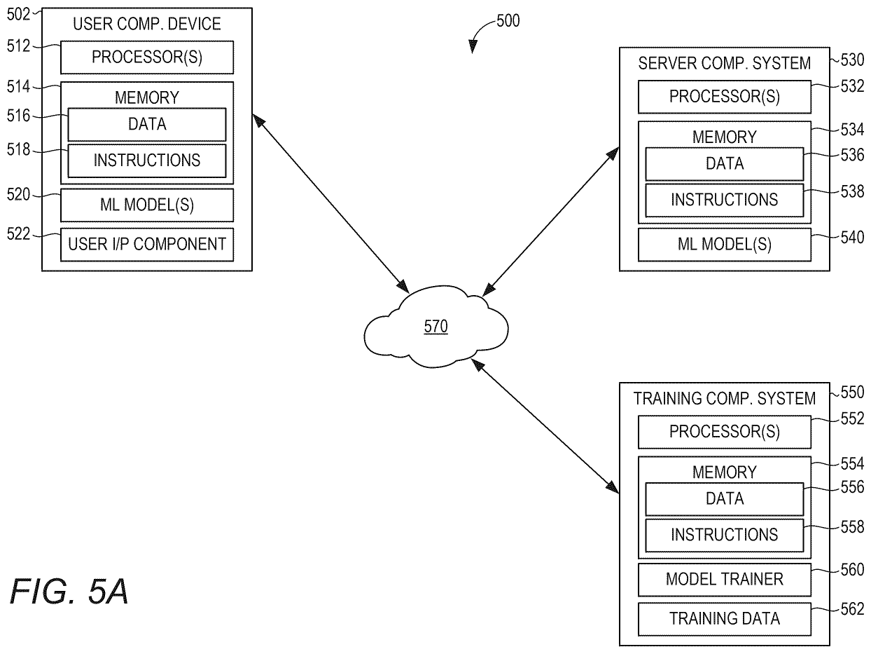

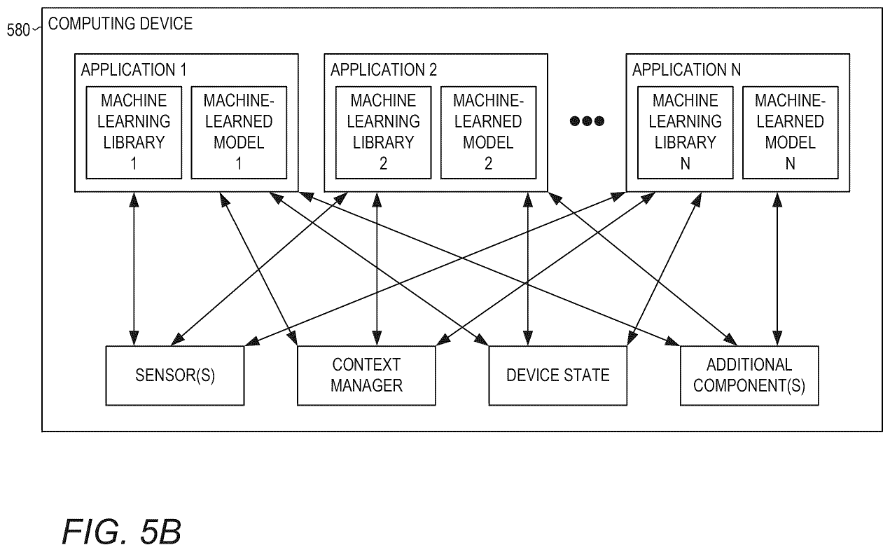

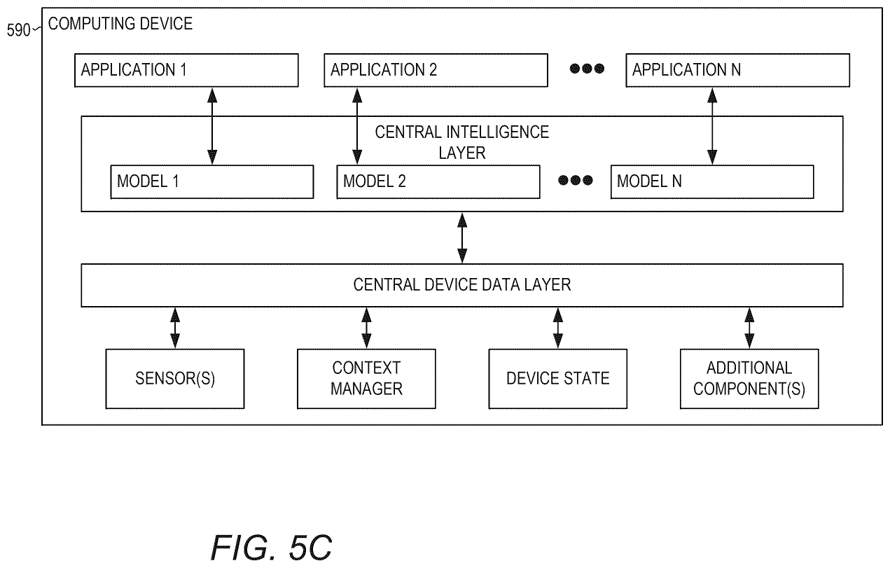

FIG. 5A depicts a block diagram of an example computing system 500 that performs the routing information determination operations disclosed herein according to example embodiments of the present disclosure. The system 500 includes a user computing device 502, a server computing system 530, and a training computing system 550 that are communicatively coupled over a network 570.

The user computing device 502 may be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 502 includes one or more processor device 512 and a memory 514. The one or more processor devices 512 may be any suitable processing device (e.g., a processor core, a microprocessor, an ASIC, an FPGA, a controller, a microcontroller, etc.) and may be one processor or a plurality of processors that are operatively connected. The memory 514 may include one or more non-transitory computer-readable storage media, such as RAM, ROM, EEPROM, EPROM, flash memory devices, magnetic disks, etc., and combinations thereof. The memory 514 may store data 516 and instructions 518 which are executed by the processor device 512 to cause the user computing device 502 to perform the routing information determination operations described herein.

In some implementations, the user computing device 502 may store or include one or more machine-learned models 520. For example, the machine-learned models 520 may be or may otherwise include various machine-learned models such as neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). Example machine-learned models 520 are discussed with reference to FIGS. 1-4.

In some implementations, the one or more machine-learned models 520 may be received from the server computing system 530 over network 570, stored in the user computing device memory 514, and then used or otherwise implemented by the one or more processor devices 512. In some implementations, the user computing device 502 may implement multiple parallel instances of a single machine-learned models model 520 (e.g., to perform parallel routing information determination operations).

More particularly, as described herein, the routing information determination models may be trained to receive routing information, such as traveled route information and/or trip metadata, that is descriptive of a route traversed by a user. The routing information determination models may be further trained to generate and/or identify a plurality of route features associated with the routing information. In some examples, the routing information determination models may be further trained to receive a routing query from the user and, in response, generate second routing information descriptive of a second route to be traversed by the user based on a degree of similarity between the routing query and one or more of a plurality of timeline entries associated with the routing information.

Additionally and/or alternatively, one or more machine-learned models 540 may be included in or otherwise stored and implemented by the server computing system 530 that communicates with the user computing device 502 according to a client-server relationship. For example, the machine-learned models 540 may be implemented by the server computing system 530 as a portion of a web service (e.g., an electronic record service). Thus, one or more models 520 may be stored and implemented at the user computing device 502 and/or one or more models 540 may be stored and implemented at the server computing system 530.

The user computing device 502 may also include one or more user input components 522 that receives user input. For example, the user input component 522 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, or other means by which a user may provide user input.

The server computing system 530 includes one or more processor devices 532 and a memory 534. The one or more processor devices 532 may be any suitable processing device (e.g., a processor core, a microprocessor, an ASIC, an FPGA, a controller, a microcontroller, etc.) and may be one processor or a plurality of processors that are operatively connected. The memory 534 may include one or more non-transitory computer-readable storage media, such as RAM, ROM, EEPROM, EPROM, flash memory devices, magnetic disks, etc., and combinations thereof. The memory 534 may store data 536 and instructions 538 which are executed by the processor device 532 to cause the server computing system 530 to perform the routing information determination operations described herein.

In some implementations, the server computing system 530 includes or is otherwise implemented by one or more server computing devices. In instances in which the server computing system 530 includes plural server computing devices, such server computing devices may operate according to sequential computing architectures, parallel computing architectures, or some combination thereof.

As described above, the server computing system 530 may store or otherwise include one or more machine-learned models 540. For example, the models 540 may be or may otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models may leverage an attention mechanism such as self-attention. For example, some example machine-learned models may include multi-headed self-attention models (e.g., transformer models). Example models 540 are discussed with reference to FIGS. 1-4.

The user computing device 502 and/or the server computing system 530 may train the models 1520 and/or 1540 via interaction with the training computing system 550 that is communicatively coupled over the network 570. The training computing system 550 may be separate from the server computing system 530 or may be a portion of the server computing system 530.

The training computing system 550 includes one or more processor devices 552 and a memory 554. The one or more processor devices 552 may be any suitable processing device (e.g., a processor core, a microprocessor, an ASIC, an FPGA, a controller, a microcontroller, etc.) and may be one processor or a plurality of processors that are operatively connected. The memory 554 may include one or more non-transitory computer-readable storage media, such as RAM, ROM, EEPROM, EPROM, flash memory devices, magnetic disks, etc., and combinations thereof. The memory 554 may store data 556 and instructions 558 which are executed by the processor device 552 to cause the training computing system 550 to perform the routing information determination operations described herein. In some implementations, the training computing system 550 includes or is otherwise implemented by one or more server computing devices.

The training computing system 550 may include a model trainer 560 that trains the machine-learned models 520 and/or 540 stored at the user computing device 502 and/or the server computing system 530 using various training or learning techniques, such as, for example, backwards propagation of errors. For example, a loss function may be backpropagated through the model(s) to update one or more parameters of the model(s) (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In some implementations, performing backwards propagation of errors may include performing truncated backpropagation through time. The model trainer 560 may perform a number of generalization techniques (e.g., weight decays, dropouts, etc.) to improve the generalization capability of the models being trained.

In particular, the model trainer 560 may train the machine-learned models 520 and/or 540 based on a set of training data 562. The training data 562 may include, for example, data that is specific to a user (e.g., timeline entries 138 (FIG. 1)) and/or anonymized data associated with other users. The training data 562 may further include, e.g., noise to reflect expected recognition errors by the framework.

In some implementations, if the user has provided consent, the training examples may be provided by the user computing device 502. Thus, in such implementations, the model 520 provided to the user computing device 502 may be trained by the training computing system 550 on user-specific data received from the user computing device 502. In some instances, this process may be referred to as personalizing the model.

The model trainer 560 includes computer logic utilized to provide desired functionality. The model trainer 560 may be implemented in hardware, firmware, and/or software controlling a general-purpose processor device. For example, in some implementations, the model trainer 560 includes program files stored on a storage device, loaded into a memory and executed by one or more processors. In other implementations, the model trainer 560 includes one or more sets of computer-executable instructions that are stored in a tangible computer-readable storage medium such as RAM, hard disk, or optical or magnetic media.

The network 570 may be any type of communications network, such as a local area network (e.g., intranet), wide area network (e.g., Internet), or some combination thereof and may include any number of wired or wireless links. In general, communication over the network 570 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure may be image data. The machine-learned model(s) may process the image data to generate an output. As an example, the machine-learned model(s) may process the image data to generate an image recognition output (e.g., a recognition of the image data, a latent embedding of the image data, an encoded representation of the image data, a hash of the image data, etc.). As another example, the machine-learned model(s) may process the image data to generate an image segmentation output. As another example, the machine-learned model(s) may process the image data to generate an image classification output. As another example, the machine-learned model(s) may process the image data to generate an image data modification output (e.g., an alteration of the image data, etc.). As another example, the machine-learned model(s) may process the image data to generate an encoded image data output (e.g., an encoded and/or compressed representation of the image data, etc.). As another example, the machine-learned model(s) may process the image data to generate an upscaled image data output. As another example, the machine-learned model(s) may process the image data to generate a prediction output.

In some implementations, the input to the machine-learned model(s) of the present disclosure may be text or natural language data. The machine-learned model(s) may process the text or natural language data to generate an output. As an example, the machine-learned model(s) may process the natural language data to generate a language encoding output. As another example, the machine-learned model(s) may process the text or natural language data to generate a latent text embedding output. As another example, the machine-learned model(s) may process the text or natural language data to generate a translation output. As another example, the machine-learned model(s) may process the text or natural language data to generate a classification output. As another example, the machine-learned model(s) may process the text or natural language data to generate a textual segmentation output. As another example, the machine-learned model(s) may process the text or natural language data to generate a semantic intent output. As another example, the machine-learned model(s) may process the text or natural language data to generate an upscaled text or natural language output (e.g., text or natural language data that is higher quality than the input text or natural language, etc.). As another example, the machine-learned model(s) may process the text or natural language data to generate a prediction output.

In some implementations, the input to the machine-learned model(s) of the present disclosure may be speech data. The machine-learned model(s) may process the speech data to generate an output. As an example, the machine-learned model(s) may process the speech data to generate a speech recognition output. As another example, the machine-learned model(s) may process the speech data to generate a speech translation output. As another example, the machine-learned model(s) may process the speech data to generate a latent embedding output. As another example, the machine-learned model(s) may process the speech data to generate an encoded speech output (e.g., an encoded and/or compressed representation of the speech data, etc.). As another example, the machine-learned model(s) may process the speech data to generate an upscaled speech output (e.g., speech data that is higher quality than the input speech data, etc.). As another example, the machine-learned model(s) may process the speech data to generate a textual representation output (e.g., a textual representation of the input speech data, etc.). As another example, the machine-learned model(s) may process the speech data to generate a prediction output.

In some implementations, the input to the machine-learned model(s) of the present disclosure may be latent encoding data (e.g., a latent space representation of an input, etc.). The machine-learned model(s) may process the latent encoding data to generate an output. As an example, the machine-learned model(s) may process the latent encoding data to generate a recognition output. As another example, the machine-learned model(s) may process the latent encoding data to generate a reconstruction output. As another example, the machine-learned model(s) may process the latent encoding data to generate a search output. As another example, the machine-learned model(s) may process the latent encoding data to generate a reclustering output. As another example, the machine-learned model(s) may process the latent encoding data to generate a prediction output.

In some implementations, the input to the machine-learned model(s) of the present disclosure may be statistical data. Statistical data may be, represent, or otherwise include data computed and/or calculated from some other data source. The machine-learned model(s) may process the statistical data to generate an output. As an example, the machine-learned model(s) may process the statistical data to generate a recognition output. As another example, the machine-learned model(s) may process the statistical data to generate a prediction output. As another example, the machine-learned model(s) may process the statistical data to generate a classification output. As another example, the machine-learned model(s) may process the statistical data to generate a segmentation output. As another example, the machine-learned model(s) may process the statistical data to generate a visualization output. As another example, the machine-learned model(s) may process the statistical data to generate a diagnostic output.

In some implementations, the input to the machine-learned model(s) of the present disclosure may be sensor data. The machine-learned model(s) may process the sensor data to generate an output. As an example, the machine-learned model(s) may process the sensor data to generate a recognition output. As another example, the machine-learned model(s) may process the sensor data to generate a prediction output. As another example, the machine-learned model(s) may process the sensor data to generate a classification output. As another example, the machine-learned model(s) may process the sensor data to generate a segmentation output. As another example, the machine-learned model(s) may process the sensor data to generate a visualization output. As another example, the machine-learned model(s) may process the sensor data to generate a diagnostic output. As another example, the machine-learned model(s) may process the sensor data to generate a detection output.

In some cases, the machine-learned model(s) may be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task may be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task may be image segmentation, where the image processing output defines, for each pixel in the one or more images, a respective likelihood for each category in a predetermined set of categories. For example, the set of categories may be foreground and background. As another example, the set of categories may be object classes. As another example, the image processing task may be depth estimation, where the image processing output defines, for each pixel in the one or more images, a respective depth value. As another example, the image processing task may be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 5A illustrates one example computing system that may be used to implement the present disclosure. Other computing systems may be used as well. For example, in some implementations, the user computing device 502 may include the model trainer 560 and the training dataset 562. In such implementations, the models 520 may be both trained and used locally at the user computing device 502. In some of such implementations, the user computing device 502 may implement the model trainer 560 to personalize the models 520 based on user-specific data.

FIG. 5B depicts a block diagram of an example computing device 580 that performs according to example embodiments of the present disclosure. The computing device 580 may be a user computing device or a server computing device.

The computing device 580 includes a number of applications (e.g., applications 1 through N). Each application contains its own machine learning library and machine-learned model(s). For example, each application may include a machine-learned model. Example applications include a text messaging application, an email application, a dictation application, a virtual keyboard application, a browser application, etc.

As illustrated in FIG. 5B, each application may communicate with a number of other components of the computing device, such as, for example, one or more sensors, a context manager, a device state component, and/or additional components. In some implementations, each application may communicate with each device component using an API (e.g., a public API). In some implementations, the API used by each application is specific to that application.

FIG. 5C depicts a block diagram of an example computing device 590 that performs according to example embodiments of the present disclosure. The computing device 590 may be a user computing device or a server computing device.

The computing device 590 includes a number of applications (e.g., applications 1 through N). Each application is in communication with a central intelligence layer. Example applications include a text messaging application, an email application, a dictation application, a virtual keyboard application, a browser application, etc. In some implementations, each application may communicate with the central intelligence layer (and model(s) stored therein) using an API (e.g., a common API across all applications).

The central intelligence layer includes a number of machine-learned models. For example, as illustrated in FIG. 5C, a respective machine-learned model may be provided for each application and managed by the central intelligence layer. In other implementations, two or more applications may share a single machine-learned model. For example, in some implementations, the central intelligence layer may provide a single model for all of the applications. In some implementations, the central intelligence layer is included within or otherwise implemented by an operating system of the computing device 590.

The central intelligence layer may communicate with a central device data layer. The central device data layer may be a centralized repository of data for the computing device 590. As illustrated in FIG. 5C, the central device data layer may communicate with a number of other components of the computing device, such as, for example, one or more sensors, a context manager, a device state component, and/or additional components. In some implementations, the central device data layer may communicate with each device component using an API (e.g., a private API).

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method, comprising:
obtaining, by a computing device comprising one or more processor devices, routing information for a route traveled by a user, the routing information comprising:
traveled route information descriptive of a first route from a first location to a second location provided to a user; and
trip metadata obtained from one or more applications executed by the computing device during traversal of the route taken by the user, the one or more applications comprising a mapping application;
storing, by the computing device, a first timeline entry in an indexing structure comprising a plurality of timeline entries, the first timeline entry being based on the routing information;
responsive to a routing query from the user, retrieving, by the computing device, the first timeline entry based on a degree of similarity between the first timeline entry and the routing query; and
generating, by the computing device, second routing information descriptive of a second route to a third location, the third location being based on the first timeline entry.

2. The method of claim 1, further comprising:
responsive to generating the second routing information, providing, by the computing device, the second routing information to the user via a display device.

3. The method of claim 1, wherein generating the second routing information further comprises:
generating, by the computing device, the second routing information descriptive of the second route to the third location and a third route to a fourth location, wherein the fourth location is based at least in part on the first timeline entry.

4. The method of claim 1, wherein storing the first timeline entry in the indexing structure comprising the plurality of timeline entries comprises:
providing, by the computing device, at least the trip metadata to a personalized computing enclave specific to the user, wherein the personalized computing enclave executes a remote instance of a machine-learned model personalized for the user;
responsive to providing the at least the trip metadata to the personalized computing enclave, receiving, by the computing device from the personalized computing enclave, a plurality of route features; and
storing, by the computing device, the first timeline entry in the indexing structure, the first timeline entry comprising the plurality of route features.

5. The method of claim 4, wherein providing at least the trip metadata to the personalized computing enclave specific to the user comprises:
establishing, by the computing device, a network connection to a remote server, the remote server configured to instantiate the personalized computing enclave;
determining, by the computing device, that the personalized computing enclave is specific to the user; and
responsive to determining that the personalized computing enclave is specific to the user, transmitting, by the computing device via the network connection, at least the trip metadata to the personalized computing enclave,
wherein the network connection is an encrypted communication link between the computing device and the remote server.

6. The method of claim 4, wherein receiving the plurality of route features comprises:
responsive to providing the at least the trip metadata to the personalized computing enclave, receiving, by the computing device from the personalized computing enclave, a first portion of the plurality of route features;
processing, by the computing device, the traveled route information with a local machine-learned model executed on the computing device to identify a second portion of the plurality of route features; and
storing, by the computing device, the first timeline entry in the indexing structure, the first timeline entry comprising the first portion of the plurality of route features and the second portion of the plurality of route features.

7. The method of claim 1, wherein storing the first timeline entry in the indexing structure comprising the plurality of timeline entries comprises:
processing, by the computing device, at least the trip metadata with a local machine-learned model executed on the computing device to identify a plurality of route features; and
storing, by the computing device, the first timeline entry in the indexing structure, the first timeline entry comprising the plurality of route features.

8. The method of claim 7, wherein retrieving the first timeline entry based on the degree of similarity between the first timeline entry and the routing query comprises:
determining, by the computing device, that at least one of the plurality of route features matches at least one corresponding second route feature of a plurality of second route features, and wherein the plurality of second route features is based on the routing query.

9. The method of claim 8, wherein determining that at least one of the plurality of route features matches at least one corresponding second route feature of a plurality of second route features comprises:
processing, by the computing device, the routing query with the local machine-learned model executed on the computing device to obtain an output descriptive of the plurality of second route features.

10. The method of claim 8, wherein determining that at least one of the plurality of route features matches at least one corresponding second route feature of a plurality of second route features comprises:
providing, by the computing device, the routing query to a personalized computing enclave specific to the user, wherein the personalized computing enclave executes a remote instance of the local machine-learned model; and
responsive to providing the routing query to the personalized computing enclave specific to the user, receiving, by the computing device from the personalized computing enclave, the plurality of second route features.

11. A computing device, comprising:
one or more processor devices; and
one or more non-transitory computer-readable media that collectively store instructions that, when executed by the one or more processors, cause the computing device to perform operations, the operations comprising:
obtaining routing information for a route traveled by a user, the routing information comprising:
traveled route information descriptive of a first route from a first location to a second location provided to a user; and
trip metadata obtained from one or more applications executed by the computing device during traversal of the route taken by the user, the one or more applications comprising a mapping application;
storing a first timeline entry in an indexing structure comprising a plurality of timeline entries, the first timeline entry being based on the routing information;
responsive to a routing query from the user, retrieving the first timeline entry based on a degree of similarity between the first timeline entry and the routing query; and
generating second routing information descriptive of a second route to a third location, the third location being based on the first timeline entry.

12. The computing device of claim 11, wherein the operations further comprise:
responsive to generating the second routing information, providing the second routing information to the user via a display device.

13. The computing device of claim 11, wherein, to store the first timeline entry in the indexing structure comprising the plurality of timeline entries, the operations comprise:
providing at least the trip metadata to a personalized computing enclave specific to the user, wherein the personalized computing enclave executes a remote instance of a machine-learned model personalized for the user;
responsive to providing the at least the trip metadata to the personalized computing enclave, receiving, from the personalized computing enclave, a plurality of route features; and
storing the first timeline entry in the indexing structure, the first timeline entry comprising the plurality of route features.

14. The computing device of claim 13, wherein, to provide at least the trip metadata to the personalized computing enclave specific to the user, the operations comprise:
establishing a network connection to a remote server, the remote server configured to instantiate the personalized computing enclave;
determining that the personalized computing enclave is specific to the user; and
responsive to determining that the personalized computing enclave is specific to the user, transmitting, via the network connection, at least the trip metadata to the personalized computing enclave,
wherein the network connection is an encrypted communication link between the computing device and the remote server.

15. The computing device of claim 13, wherein, to receive the plurality of route features, the operations comprise:
responsive to providing the at least the trip metadata to the personalized computing enclave, receiving, from the personalized computing enclave, a first portion of the plurality of route features;
processing the traveled route information with a local machine-learned model executed on the computing device to identify a second portion of the plurality of route features; and
storing the first timeline entry in the indexing structure, the first timeline entry comprising the first portion of the plurality of route features and the second portion of the plurality of route features.

16. The computing device of claim 11, wherein, to store the first timeline entry in the indexing structure comprising the plurality of timeline entries, the operations comprise:
processing at least the trip metadata with a local machine-learned model executed on the computing device to identify a plurality of route features; and
storing the first timeline entry in the indexing structure, the first timeline entry comprising the plurality of route features.

17. The computing device of claim 16, wherein, to retrieve the first timeline entry based on the degree of similarity between the first timeline entry and the routing query, the operations comprise:
determining that at least one of the plurality of route features matches at least one corresponding second route feature of a plurality of second route features, wherein the plurality of second route features is based on the routing query.

18. The computing device of claim 17, wherein, to determine that at least one of the plurality of route features matches at least one corresponding second route feature of a plurality of second route features, the operations comprise:
processing, the routing query with the local machine-learned model executed on the computing device to obtain an output descriptive of the plurality of second route features.

19. The computing device of claim 17, wherein, to determine that at least one of the plurality of route features matches at least one corresponding second route feature of a plurality of second route features, the operations comprise:
providing the routing query to a personalized computing enclave specific to the user, wherein the personalized computing enclave executes a remote instance of the local machine-learned model; and
responsive to providing the routing query to the personalized computing enclave, receiving, from the personalized computing enclave, the plurality of second route features.

20. A non-transitory computer-readable medium comprising instructions that, when executed by one or more processors of a computing device, cause the one or more processors to perform operations, the operations comprising:
obtaining routing information for a route traveled by a user, the routing information comprising:
traveled route information descriptive of a first route from a first location to a second location provided to a user; and
trip metadata obtained from one or more applications executed by the computing device during traversal of the route taken by the user, the one or more applications comprising a mapping application;
storing a first timeline entry in an indexing structure comprising a plurality of timeline entries, the first timeline entry being based on the routing information;
responsive to a routing query from the user, retrieving the first timeline entry based on a degree of similarity between the first timeline entry and the routing query; and
generating second routing information descriptive of a second route to a third location, the third location being based on the first timeline entry.
